(19) United States
(12) Patent Application Publication
(10) Pub. No.: US 2006/0115630 A1
(43) Pub. Date: Jun. 1, 2006

(54) Image element with electrostatic transport capability

(75) Inventors: Mark C. Zaretsky, Rochester, NY (US); David M. Rakov, Rochester, NY (US); William J. Hagen, Hilton, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/000,126

(22) Filed: Nov. 30, 2004

(51) Int. Cl. B32B 27/32; B32B 27/10; B41M 5/00

(52) U.S. Cl. 428/195.1; 428/523; 428/513

(57) ABSTRACT

The invention relates to an image receiving element comprising in order a support, at least one polyolefin resin coating and at least one image receiving layer, wherein the volume resistivity of the element as measured through its thickness is substantially greater than 1×10¹² ohm-cm and the internal resistivity of the element is greater than 1×10¹⁰ ohm/square.

### FIELD OF THE INVENTION

The invention relates to an image receiving element to be electrostatically tacked to a conveying structure, usually in the form of a transport belt, for transport through an imaging machine such as an electrophotographic printer. In a preferred form it relates to an imaging element comprising a toner receiving layer that provides photographic quality print using electrophotography and is fuser oil absorbent, glossable, writable and fingerprint resistant, has good toner adhesion and has good electrostatic transport capability.

### BACKGROUND OF THE INVENTION

In the prior art it is known to apply insulating plastic layers such as polyolefin resin on one or both sides of a core, for example a cellulosic paper base, to provide an image receiving element with high image quality and improved physical properties, such as waterproofing to the paper base and a smooth surface on which the image receiving layers are formed, as for example described in U.S. Pat. No. 3,501,298. In order to control static generation during the manufacturing process of an image receiving element such as photographic paper, it is known to control the salt content during manufacture of the cellulosic paper base. U.S. Pat. No. 3,082,123 describes incorporation of sodium salt into the paper base manufacture at levels in the range of 0.5 to 1.0 g/m².

European Patent Application 1,336,901 A1 describes an electrophotographic image receiving sheet with a toner image receiving layer containing a release agent and formed on a support sheet for use in a fixing belt type electrophotography. The support used in the examples had a paper core with polyethylene layers on either side, where the image side is glossy and the backside has a matte finish. These insulating plastic layers typically prevent any significant electrostatic charge flow through the thickness of the image receiving element however, the interior static dissipative cellulosic core can allow significant electrostatic charge flow in the plane of the substrate.

It is also known in the prior art to electrostatically tack a sheet of paper or other imaging media to a conveying belt by applying a charge to the surface of the media with a polarity opposite to that of the charge applied to the transport belt. The charge may be applied to the media and belt surfaces using a number of techniques including a corona charger or biased roller. This results in an electrostatic force of attraction that tacks the media to the belt, enabling sequential transfer of images in register, onto the media for the production of a multi-color print. U.S. Pat. No. 2,576,882 to Koole et al. is an example of one such prior art device. Another example is provided in U.S. Pat. No. 5,740,512 where guides (referred to as shoots in the patent) are used to direct the image receiving element to the electrostatic tackdown unit.

The electrical properties of the media and the transport belt are critical to this electrostatic tackdown process. In U.S. Pat. No. 5,907,758, the transport belt is described as a dielectric belt having high volume resistivity, greater than or equal to 1.0×10¹³ ohm-cm. In U.S. Pat. No. 5,602,633, the transport belt volume resistivity is defined to be a function of its relative dielectric constant, conveying speed and running distance from a peeling position.

In U.S. Pat. No. 3,981,498, a description is provided for an enhancement of the tackdown force via the deposition of a non-uniform electrostatic charge pattern on the media. The lateral surface electrical resistivity of the media is specified to be at least about 3×10¹⁴ ohms/square in order to preserve this non-uniform charge pattern during the electrophotographic print process. No consideration is given for a media having the structure proposed in this application wherein a static dissipative core is covered on either one or both sides by a dielectric material.

In EP 1,336,901 an image receiving sheet is described having a toner image receiving layer with specified surface electrical resistivity in a range of 10⁶ to 10¹⁵ ohm/square, desirably in a range of 5×10⁸ to 3.2×10¹⁰ ohm/square, and most desirably from 10⁹ to 10¹⁰ ohm/square. This patent only specifies the surface resistivity of the toner image receiving layer, it does not consider the implications of this surface resistivity upon an electrostatic tackdown process nor does it define the electrical resistivity of the entire receiving sheet.

In U.S. Pat. Nos. 6,365,317 and 6,440,540, a receiver material is described having a volume resistivity in the range of 10⁸ to 10¹³ ohm-cm. This patent again does not consider the implications of this volume resistivity upon an electrostatic tackdown process.

### PROBLEM TO BE SOLVED BY THE INVENTION

There exists a need for providing an image receiving element capable of being reliably transported through a print engine using an electrostatic tackdown process to adhere the element to a transport belt.

### SUMMARY OF THE INVENTION

It is an object of the invention to provide an image receiving element that can be transported reliably using an electrostatic tackdown process and a transport belt.

It is another object to provide an image receiving element for electrophotographic printing that produces near photoquality prints

These and other objects of the invention are accomplished by providing an image receiving element comprising in order a core, at least one polyolefin resin coating and at least one image receiver layer, wherein the volume resistivity of the element as measured through its thickness is substantially greater than 1×10¹² ohm-cm and the internal resistivity of the element is greater than 1×10¹⁰ ohm/square. Preferably, volume resistivity is between 1×10¹² and 1×10¹⁶ ohm-cm, and the internal resistivity of the element is between 3.2×10¹⁰ and 1×10¹² ohm/square.

### ADVANTAGEOUS EFFECT OF THE INVENTION

The invention provides an image receiving element capable of being reliably transported through a print engine using an electrostatic tackdown process to adhere the element to a transport belt.

### BRIEF DESCRIPTION OF THE DRAWINGS

FIG. 1a is a cross-sectional view of a prototypical image receiving element having a core and one image receiving layer.

FIG. 1b is a cross-sectional view of a prototypical image receiving element having a core, an insulating plastic layer, and one image receiving layer.

FIG. 1c is a cross-sectional view of a prototypical image receiving element having a core, and, on both sides of the core, an insulating plastic layer, and one image receiving layer.

FIG. 2 is a schematic drawing of the conveyance of the image receiving element to the transport belt and passing through an electrostatic tackdown apparatus.

### DETAILED DESCRIPTION OF THE INVENTION

The invention has numerous advantages. The invention provides an image receiving element capable of being reliably transported through a print engine using an electrostatic tackdown process to adhere the element to a transport belt. Further, the invention provides an image receiving element having a construction wherein the external layers may be highly insulating and provide excellent image quality while the internal core may be static dissipative and provide excellent physical properties such as stiffness, caliper, and low curl.

With respect to an electrophotographic print engine, the invention provides a paper for electrophotographic printing that can provide near photo quality high gloss prints, where differential gloss, image relief, and residual surface fuser oil are minimized and toner adhesion is maximized, exhibits fingerprint resistance and water resistance compared to commercially available clay coated papers and further exhibits improved writability on the media after imaging and/or glossing, particularly on the backside and on portions of the front side intended for writing. The paper also provides an excellent degree of whiteness. The paper also exhibits reliable electrostatic tackdown and transport through the print engine. These and other advantages will be apparent from the detailed description below.

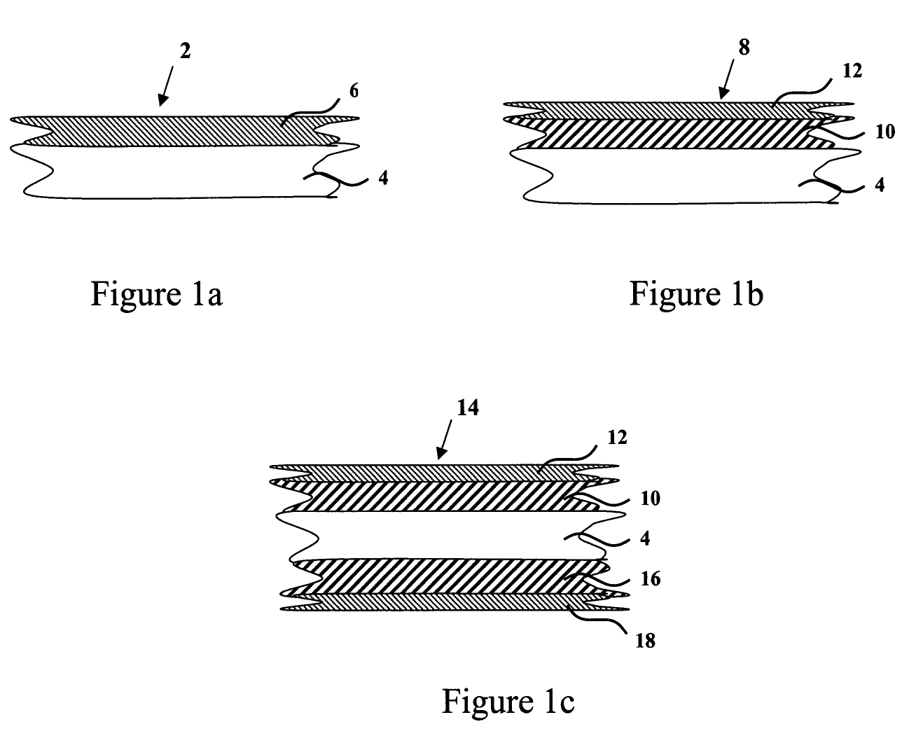

In FIG. 1a is shown one embodiment of the invention whereby the image receiving element 2 of this invention comprises a core 4 and an image receiving layer 6. In FIG. 1b is shown another embodiment of the invention whereby the image receiving element 8 of this invention comprises a core 4, a polyolefin layer 10, and an image receiving layer 12. FIG. 1c shows a preferred embodiment of the invention, similar to that shown in FIG. 1b except that in image receiving element 14 both sides of core 4 have a polyolefin layer 10 and 16, and an imaging receiving layer 12 and 18, providing the capability for producing a duplex print with images printed on both sides of element 14.

The core as used herein refers to a base or a substrate material that is the primary part of an imaging element such as paper, polyester, vinyl, synthetic paper, fabric, or other suitable material for the viewing of images. The base for use in the present invention may be any support typically used in imaging applications. Typical base may be fabrics, paper, and polymer sheets. While it is recognized that the preferred base of this invention would be paper and hence static dissipative, it is known in the art to render plastics and fabrics static dissipative and therefore these materials may also represent base materials of interest for this invention. The base may either be transparent or opaque, reflective or non-reflective. The term as used herein, “transparent” means the ability to pass radiation without significant deviation or absorption. Opaque base include plain paper, coated paper, synthetic paper, low density foam core based substrate and low density foam core based paper. The base can also consist of microporous materials such as polyethylene polymer-containing material sold by PPG Industries, Inc., Pittsburgh, Pa. under the trade name of Teslin®, Tyvek® synthetic paper (DuPont Corp.), impregnated paper such as Duraform®, and OPPalyte® films (Mobil Chemical Co.) and other composite films listed in U.S. Pat. No. 5,244,861. Transparent base include glass, cellulose derivatives, such as a cellulose ester, cellulose triacetate, cellulose diacetate, cellulose acetate propionate, cellulose acetate butyrate, polyesters, such as poly(ethylene terephthalate), poly(ethylene naphthalate), poly-1,4-cyclohexanedimethylene terephthalate, poly(butylene terephthalate), and copolymers thereof, polyimides, polyamides, polycarbonates, polystyrene, polyolefins, such as polyethylene or polypropylene, polysulfones, polyacrylates, polyether imides, and mixtures thereof The papers listed above include a broad range of papers, from high end papers, such as photographic paper to low end papers, such as newsprint. The support used in the invention may have a thickness of from about 50 to about 500 μm, preferably from about 75 to 300 μm. A preferred base, and one that is illustrated in the examples below, is a white paper of photographic quality that has been sized or treated to bring its sheet resistance to greater than 1×10¹⁰ ohm/square. This sheet resistance can be controlled by the salt and moisture content of the paper during the manufacturing process. Typical moisture contents range from 3% to 9% by weight. Typical salt contents range from 0 to 1.5 g/m². Typical salts used are inorganic salts such as sodium chloride that are added at the size press in starch formulations.

The imaging supports utilized with this invention can comprise any number of auxiliary layers, for example, functional layers. Such auxiliary layers may include conveyance layers, barrier layers, splice providing layers, UV absorption layers, and waterproofing layers.

The polyolefin resin coated on the base to form a support can be any melt extrusion coatable polyolefin material known in the art. Suitable polymers for the polyolefin resin coating include polyethylene, polypropylene, polymethylpentene, polystyrene, polybutylene, and mixtures thereof Polyolefin copolymers, including copolymers of polyethylene, propylene and ethylene such as hexene, butene, and octene are also useful. The polyolefin may also be copolymerized with one or more copolymers including polyesters, such as polyethylene terephthalate, polysulfones, polyurethanes, polyvinyls, polycarbonates, cellulose esters, such as cellulose acetate and cellulose propionate, and polyacrylates. Specific examples of copolymerizable monomers include vinyl stearate, vinyl acetate, acrylic acid, methyl acrylate, ethyl acrylate, acrylamide, methacrylic acid, methyl methacrylate, ethyl methacrylate, methacrylamide, butadiene, isoprene, and vinyl chloride.

Polyethylene is preferred for coated paper supports, as it is low in cost and has desirable coating properties. Preferred polyolefins are film forming and adhesive to paper. Usable polyethylenes may include high density polyethylene, low density polyethylene, linear low density polyethylene, and polyethylene blends. Polyethylene having a density in the range of from 0.90 g/cm³ to 0.980 g/cm³ is particularly preferred. The polyolefin resin, such as polypropylene, may be used when the support created is a laminated structure of paper and one or more biaxially or uniaxially oriented polypropylene films.

It is desirable to incorporate white pigments in the polyolefin resin layer to give the required optical properties for the paper. Any suitable white pigment may be incorporated in the polyolefin resin layers, such as, for example, zinc oxide, zinc sulfide, zirconium dioxide, white lead, lead sulfate, lead chloride, lead aluminate, lead phthalate, antimony trioxide, white bismuth, tin oxide, white manganese, white tungsten, and combinations thereof The preferred pigment is titanium dioxide (TiO₂) because of its high refractive index, which gives excellent optical properties at a reasonable cost. The pigment is used in any form that is conveniently dispersed within the polyolefin. The preferred pigment is anatase titanium dioxide. The most preferred pigment is rutile titanium dioxide because it has the highest refractive index at the lowest cost. The average pigment diameter of the rutile TiO₂ is most preferably in the range of 0.1 to 0.26 μm. The pigments that are greater than 0.26 μm are too yellow for an imaging element application and the pigments that are less than 0.1 μm are not sufficiently opaque when dispersed in polymers. Preferably, the white pigment should be employed in the range of from about 7 to about 50 percent by weight, based on the total weight of the polyolefin coating. Below 7 percent TiO₂, the imaging system will not be sufficiently opaque and will have inferior optical properties. Above 50 percent TiO₂, the polymer blend is not manufacturable.

The polyolefin resins and TiO₂ and optional other additives may be mixed with each other in the presence of a dispersing agent. Examples of dispersing agents are metal salts of higher fatty acids such as sodium palmitate, sodium stearate, calcium palmitate, sodium laurate, calcium stearate, aluminum stearate, magnesium stearate, zirconium octylate, or zinc stearate higher fatty acids, higher fatty amide, and higher fatty acids. The preferred dispersing agent is sodium stearate and the most preferred dispersing agent is zinc stearate. Both of these dispersing agents give superior whiteness to the resin coated layer.

In addition, it may be necessary to use various additives such as colorants, brightening agents, antistatic agents, plasticizers, antioxidants, slip agents, or lubricants, and light stabilizers in the resin coated supports as well as biocides in the paper elements. These additives are added to improve, among other things, the dispersibility of fillers and/or colorants, as well as the thermal and color stability during processing and the manufacturability and the longevity of the finished article. For example, the polyolefin coating may contain antioxidants such as 4,4′-butylidene-bis(6-tert-butyl-meta-cresol), di-lauryl-3,3′-thiopropionate, N-butylated-p-aminophenol, 2,6-di-tert-butyl-p-cresol, 2,2-di-tert-butyl-4-methyl-phenol, N,N-disalicylidene-1,2-diaminopropane, tetra(2,4-tert-butylphenyl)-4,4′-diphenyl diphosphonite, octadecyl 3-(3′,5′-di-tert-butyl-4′-hydroxyphenyl propionate), combinations of the above, and the like; heat stabilizers, such as higher aliphatic acid metal salts such as magnesium stearate, calcium stearate, zinc stearate, aluminum stearate, calcium palmitate, zirconium octylate, sodium laurate, and salts of benzoic acid such as sodium benzoate, calcium benzoate, magnesium benzoate and zinc benzoate; light stabilizers such as hindered amine light stabilizers (HALS), of which a preferred example is poly{[6-[(1,1,3,3-tetramethylbutylamino}-1,3,5-triazine-4-piperidinyl)-imino]-1,6-hexanediyl[{2,2,6,6-tetramethyl-4-piperdinyl)imino]}(Chimassorb 944 LD/FL).

The polyolefin resin coating on the support can include multilayer polyolefin structures, such as those achieved by multiple coatings, either sequential or via coextrusion. To minimize the number of resins required, a structure consisting of 1 to 3 layers on each side is preferred. In one embodiment of the present invention, at least one or all the layers can further comprise polypropylene. In a 3-layer structure, two of the three layers on each side may have substantially similar composition, preferably the two outside layers. The ratio of thickness of the center or bottom layer to an outside layer is in the range of 1 to 8 with 5 to 7 being most preferable. The polyolefin resin of the outside layers may contain, optionally, pigments and other addenda.

The coating of the paper base material for support formation with the polyolefin preferably is by extrusion from a hot melt as is known in the art. The invention may be practiced within a wide range of extrusion temperatures, for example, from 150° C. to 350° C., and speeds, for example, from 60 m/min. to 460 m/min., depending on the particular intended application of the support. For many applications, preferred extrusion temperatures are from 300° C. to 330° C.

For the case of an image receiving element for use in an electrophotographic print engine, the electrophotographic processes and their individual steps have been well described in detail in many books and publications. The processes incorporate the basic steps of creating an electrostatic image, including charging and exposing a photoconductor, developing that image with charged, colored particles (toner), optionally transferring the resulting developed image to a secondary substrate, such as a cylinder with a rubber-like soft-elastic surface or a rubber blanket, and then transferred onto a final substrate or receiver and fixing or fusing the image onto the receiver. The final substrate can have an image receiving layer, also referred to as a toner receiving layer when used in an electrophotographic print engine, designed to receive the toner particles. There are numerous variations in these processes and basic steps; the use of liquid toners in place of dry toners is simply one of those variations. Another variation is the use of a transport belt to reliably convey a receiver through part or all of the print engine, with the use of electrostatic forces to firmly tack down the receiver to the transport belt.

To fix the toner pattern to the toner receiving layer, the toner on the receiving sheet is subjected to heat and pressure, for example, by passing the sheet through the nip of fusing rolls. Both the toner polymer and the thermoplastic polymer of the toner receiving layer are softened or fused sufficiently to adhere together under the pressure of the fusing rolls. When both the toner receiving layer and the toner soften and fuse, the toner can be at least partially embedded in the thermoplastic toner receiving layer. For self-fixing toners, residual liquid is removed from the paper by air-drying or heating. Upon evaporation of the solvent these toners form a film bonded to the paper. For heat-fusible toners, thermoplastic polymers are used as part of the particle. Heating both removes residual liquid and fixes the toner to paper. The fusing step can be accomplished by the application of heat and pressure to the final image. Fusing can provide increased color saturation, improved toner adhesion to the receiver, and modification of the image surface texture. A fusing device can be a cylinder or belt. The fusing device can have an elastomeric coating which provides a conformable surface to enable improved heat transfer to the receiver. The fusing device can have a smooth or textured surface. The fusing step can be combined with the transfer step.

A belt fusing apparatus as described in U.S. Pat. No. 5,895,153 can be used to provide high gloss finish to the electrophotographically printed image receiving element of this invention. The belt fuser can be separate from or integral with the reproduction apparatus. When using the belt fuser as a secondary step, the toned image is at first fixed by passing the electrophotographically printed sheet through the nip of fusing rolls within the reproduction apparatus and then subjected to belt fusing to obtain a high uniform glossy finish. The belt fusing apparatus includes an input transport for delivering marking particle image-bearing receiver members to a fusing assembly. The fusing assembly comprises a fusing belt entrained about a heated fusing roller and a steering roller, for movement in a predetermined direction about a closed loop path. The fusing belt is, for example, a thin metallic or heat resistant plastic belt. Metal belts can be electroformed nickel, stainless steel, aluminum, copper or other such metals, with the belt thickness being about 2 to 5 mils. Seamless plastic belts can be formed of materials such as polyimide, polypropylene, or the like, with the belt thickness summarily being about 2 to 5 mils. Usually these fusing belts are coated with thin hard coatings of release material such as silicone resins, fluoropolymers, or the like. The coatings are typically thin (1 to 10 microns), very smooth, and shiny. Such fusing belts could also be made with some textured surface to produce images of lower gloss or texture.

The toner used in electrophotographic print engines typically contains, for example, a polymer (a binder resin), a colorant and an optional releasing agent.

For application of this invention with respect to an electrophotographic print engine, the image receiving element utilized with this invention further comprises a toner receiving layer containing a polymer coated on both surfaces of the above mentioned support coated with a polyolefin resin. The toner receiving layer has the function of receiving an image-forming toner from a developing drum or an intermediate transfer medium by (static) electricity, pressure, etc. in the transferring step and fixing the image by heat, pressure, etc. in the fixing step. Further, it also enables the entire surface of the element develop a substantially uniform gloss after the fusing step, particularly after the belt fusing step. The resulting electrophotographic image has the look and feel of a silver halide photographic print. This is not possible on a commercially available standard paper since during the fusing step the thermoplastic is present only in the image areas leading to high differential gloss and difficulty in belt fusing due to differential adhesion forces of various areas of the print to the heated belt.

The image receiving layer utilized with this invention, referred to as a toner receiving layer when used in an electrophotographic print engine, comprises a thermoplastic polymer or thermoplastic blend of polymers or a component of the thermoplastic blend of polymers that has a glass transition temperature or T_{g} that is close to that of the thermoplastic toner that is transferred to the image receiving layer. Preferably, the T_{g} of the image receiving layer or a component of the image receiving layer is within 10° C. of the T_{g} of the toner. In the case of where only the resin component of the image receiving layer has a T_{g} close to the T_{g} of the toner, then, the rest of the polymer matrix of the toner receiving layer should preferably have a significantly lower T_{g} but is a semi-crystalline polymer. In such a case, the preferred polymer matrix of the toner receiver layer is a polyolefin. Consequently, both the toner and the receiving layers often soften or melt when the toner is fixed to the receiving layer by heat and pressure. This contributes to the adhesion of the toner to the layer and to achieving of high gloss in both the toned (D max) and untoned (D min) areas of the image resulting in unnoticeable differential gloss. High gloss and low differential gloss give the resultant prints a photo quality look and feel.

Materials useable for the image receiving layer include a thermoplastic polymer which is capable of being deformed at the fixing temperature and also capable of receiving the toner and providing uniform gloss after fusing. It is preferred that the T_{g} of the image receiving layer or a resin component of the image receiving layer be between 40 and 100° C. preferably between 40 and 85° C.

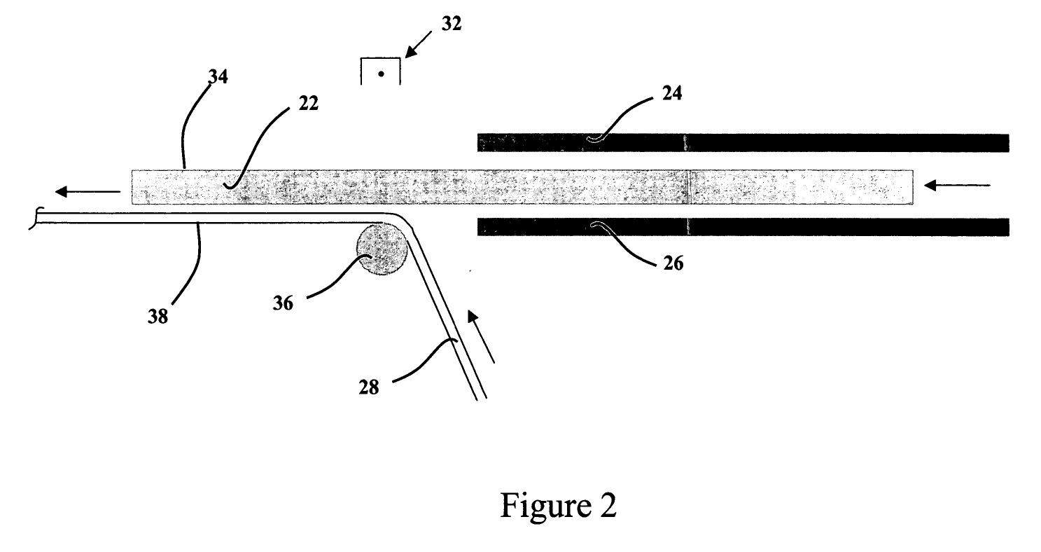

In FIG. 2 is shown one embodiment for the conveyance of the image receiving element to the transport belt while passing through an electrostatic tackdown apparatus. Image receiving element 22 is guided to transport belt 28 while passing between electrically grounded, conductive guides 24 and 26 in such a manner that element 22 is either contacting or in close proximity to one or both guides 24 and 26. As is well known in the art of electrostatics, a corona charger 32 may be employed for depositing electrostatic charge on a surface such as an image receiving element. Shortly after element 22 contacts belt 28 an electrostatic charge of one polarity is deposited on the upper surface 34 of element 22 using corona charger 32. This charge on the upper surface 34 of element 22 creates a strong electric field in the air gap between belt 28 and electrically grounded, conductive roller 36 at the leaving nip, exceeding the air breakdown threshold and thus depositing charge of the opposite polarity onto back surface 38 of belt 28. The electrostatic force of attraction between opposite charges on surfaces 34 and 38 electrostatically adhere element 22 to belt 28, enabling reliable conveyance of element 22 through the remainder of the imaging engine not shown in FIG. 2, for instance, providing sequential transfer of images in register, onto the element for the production of a multi-color print.

Measurement of the volume resistivity through the thickness of the media is made using the general procedures outlined in ASTM standard D257. More specifically, a set of Monroe electrodes, Model 96117-1, is used in conjunction with a Keithley Model 6517A Electrometer/High Resistance Meter. A voltage of 200V is applied and the resistance value is recorded after 20 seconds of the voltage application. Measurement of the internal resistivity in the plane of the media is made using the salt bridge method, described in R. A. Elder, “Resistivity Measurements on Buried Conductive Layer's”, EOS/ESD Symposium Proceedings, September 1990, pages 251-254).

When using an image receiving element as shown in FIG. 1c, consisting of a cellulosic core, polyethylene plastic layers, and image receiving layers as described above, it has been found that, when transporting said media in a NexPress 2100, that there is a failure in the electrostatic tackdown process to a dielectric transport belt if the internal resistivity of the media, as measured in the plane of the media, is below 1×10¹⁰ ohm/square, even though the volume resistivity through the thickness of the media is substantially greater than 1×10¹² ohm-cm. Surprisingly, it is found that if the internal resistivity of the media is increased to 3.2×10¹⁰ ohm/square or greater, for example, by drying the media so as to reduce the moisture content of the paper core, then reliable tackdown and transport is observed.

It is believed that when the internal resistivity of the media is below 1×10¹⁰ ohm/square, then the static dissipative core can allow for charge redistribution within the core in response to both the tackdown charge deposited on upper surface 34 and the proximity of the electrically grounded, conductive guides 24 and 26, resulting in a strong electrostatic attractive force between the media and the guides. This force of attraction creates a tangential drag force opposing the frictional pull force arising from the electrostatic tackdown of the media to the transport belt. This tangential drag force can be of sufficient magnitude so as to overwhelm the tackdown pull force, preventing good electrostatic adhesion of the media to the belt and causing transport failures. However, when the internal resistivity of the media is above 1×10¹⁰ ohm/square or greater, more preferably above 3.2×10¹⁰ ohm/square, then the charge redistribution within the media is greatly reduced, thereby greatly reducing the tangential drag force and enabling reliable tackdown and transport of the media.

While the invention has been described with reference to the preferred toner image receiving member, it will find use with other image receiving members that have a static dissipative support such as paper. Such other image receiving members include those utilized in ink jet imaging, thermal transfer imaging, flexographic, electrographic, or any other cut-sheet image process where electrostatic tackdown is utilized.

The following examples illustrate the practice of this invention. They are not intended to be exhaustive of all possible variations of the invention. Parts and percentages are by weight unless otherwise indicated.

### EXAMPLES

The polyester binder used in the following examples was a polyester ionomer, AQ55, purchased from Eastman Chemical Company. Kaogloss 90, kaolin clay was obtained from Theile Kaolin Company as a 70 wt. % dispersion in water. Aerosol® OT, dioctyl sodium sulfosuccinate, an anionic surfactant from Cytec Industries was used as the coating surfactant for the toner receiving layers coated from water. Styrene butylmethacrylate (SBM) copolymer was obtained from Scientific Polymer Products, Inc. Kao C, a bisphenol type polyester resin was obtained from Kao Corporation. Pliolite AC80-H, a styrene-acrylate copolymer was obtained from Eliokem Inc. Cloisite 15A, clay used in the toner receiving layers coated from solvent was obtained from Southern Clay Products, Inc. Polymeric matte particles were prepared using standard suspension polymerization methods.

A polyethylene resin melt containing 11.4 wt % TiO₂, 87.7 wt % LDPE, and 0.9 wt % of a mixture of colorants, optical brighteners and antioxidants, was extrusion coated on both sides of a 160 micrometer thick photographic paper support at 288-332° C. The surface finish of the resin coated paper was controlled by the finish on the chill roll used in the extrusion process. Polyethylene resin coated paper prepared thus was used for all the examples below.

For the image receiving layer, also referred to as the electrophotographic toner receiving layer (TRL), a 32 weight percent aqueous solution of a mixture of AQ55 and Kaogloss 90 in a the weight ratio specified in the Table 1 was coated on a corona discharge-treated, polyethylene resin coated paper described above to yield a dry coverage of 10.76 g/m² coating of AQ55.

The internal resistivity of the media was varied by conditioning the media to different relative humidity (RH) environments so as to change the moisture content of the paper. Three different levels of RH were chosen such that the internal resistivity levels were: Sample A—3.2×10¹⁰ ohm/square, Sample B—1×10¹⁰ ohm/square, and Sample C—4×10⁹ ohm/square, corresponding to levels of moisure content by weight percent of 5.5, 6.2, and 7.0%.

Samples A, B, and C were printed in the NexPress 2100 printer. The data of this example is summarized in Table 1. As shown in Table 1, sample A, having the highest internal resistivity, was able to be tacked down to the transport belt at the nominal settings for the tackdown corona charger (20 μA tackdown current) transported reliably through the printer. Sample B, having the middle level of internal resistivity, required a 50% increase in tackdown corona charger output in order to be tacked down to the transport belt and transport reliably through the printer. Sample C, having the lowest level of internal resistivity, was unable to be tacked down even with the tackdown corona charger output adjusted to its highest level of 40 μA. Hence sample C was unable to be transported through the printer.

TABLE 1

| | | Internal | Tackdown | |
|---|---|---|---|---|
| | % Moisture | Resistivity | Current | Tackdown |
| Sample ID | Content | (ohm/square) | (μA) | Response |
| A (invention) | 5.5 | 3.2 × 10¹⁰ | 20 | Good |
| B (invention) | 6.2 | 1.0 × 10¹⁰ | 30 | Marginal |
| C (control) | 7.0 | 4.0 × 10⁹ | 40 | Bad |

The invention has been described in detail with particular reference to certain preferred embodiments thereof, but it will be understood that variations and modifications can be effected within the spirit and scope of the invention. For example, although control of the internal resistivity of the samples was obtained by varying the moisture content of the paper, it is also possible to control this resistivity by varying the salt content of the paper core.

1. An image receiving element comprising in order a support, at least one polyolefin resin coating and at least one image receiving layer, wherein the volume resistivity of the element as measured through its thickness is substantially greater than 1×10¹² ohm-cm and the internal resistivity of the element is greater than 1×10¹⁰ ohm/square.

2. The image receiving element of claim 1 wherein said at least one image receiving layer comprises a toner receiving layer.

3. The image receiving element of claim 1 wherein internal resistivity is controlled by regulating salt content.

4. The image receiving element of claim 1 wherein the moisture content of said support is between 3 and 9%.

5. The image receiving element of claim 4 wherein said support comprises paper.

6. The image receiving element of claim 1 wherein said volume resistivity is between 1×10¹² and 1×10¹⁶ ohm-cm.

7. The image receiving element of claim 1 wherein said internal resistivity is between 3.2×10¹⁰ and 1×10¹² ohm/square.

8. A method of transporting comprising providing an image receiving element comprising in order a support, at least one polyolefin resin coating and at least one image receiving layer, wherein the volume resistivity of the element as measured through its thickness is substantially greater than 1×10¹² ohm-cm and the internal resistivity of the element is greater than 1×10¹⁰ ohm/square, passing said element between guides leading to a dielectric transport belt, tacking said element to said dielectric belt by applying an electrostatic charge to the side of said element opposite said belt, wherein said element does not transport significant electrostatic charge to said guides.

9. The method of claim 8 wherein said at least one image receiving layer comprises a toner receiving layer.

10. The method of claim 8 wherein internal resistivity is controlled by regulating salt content.

11. The method of claim 8 wherein the moisture content of said support is between 3 and 9%.

12. The method of claim 11 wherein said support comprises paper.

13. The method of claim 8 wherein said volume resistivity is between 1×10¹² and 1×10¹⁶ ohm-cm.

14. The method of claim 8 wherein said internal resistivity is between 3.2×10¹⁰ and 1×10¹² ohm/square.

15. The method of claim 10 wherein said salt content is between 0 and 1.5 g/m² of said support.

16. The method of claim 10 wherein said salt comprises an inorganic salt such as sodium chloride.
